(19) United States
(12) Patent Application Publication
(10) Pub. No.: US 2018/0276987 A1
(43) Pub. Date: Sep. 27, 2018

(54) Method and Device for the Normalisation of Ultrasonic Echo Signal Data

(71) Applicants: Volker Mathis Lücken, Aachen (DE); Nils Voß, Aachen (DE)

(72) Inventors: Volker Mathis Lücken, Aachen (DE); Nils Voß, Aachen (DE)

(73) Assignee: ICE Gateway GmbH, Berlin (DE)

(21) Appl. No.: 15/989,376

(22) Filed: May 25, 2018

Related U.S. Application Data
(63) Continuation of application No. PCT/EP2016/078830, filed on Nov. 25, 2016.

(30) Foreign Application Priority Data
Nov. 27, 2015 (DE) 10 2015 120 655.2

(51) Int. Cl. G08G 1/01; G08G 1/04; G01S 15/89; G01S 7/00

(52) U.S. Cl. CPC G08G 1/0116; G08G 1/04; G01S 7/52004; G01S 15/8979; G01S 7/003; G08G 1/0133

(57) ABSTRACT

A method is disclosed in which ultrasonic echo signal data is obtained. The ultrasonic echo signal data at least partially represent an ultrasonic echo signal detected by an ultrasonic sensor. The ultrasonic echo signal data is normalised, which involves normalising at least one first data point of the ultrasonic echo signal data at least partially as a function of at least one second data point of the ultrasonic echo signal data. The first data point represents the value of the signal strength of the detected ultrasonic echo signal at a first detection time. The second data point of the ultrasonic echo signal data represents the value of the signal strength of the detected ultrasonic echo signal at an earlier second detection time. Normalised ultrasonic echo signal data including the normalised first data point are obtained as a result of normalising the ultrasonic echo signal data.

### CROSS-REFERENCE TO RELATED PATENT APPLICATIONS

This patent application is a continuation of PCT/EP2016/078830, filed Nov. 25, 2016, which claims priority to German Application No. 10 2015 120 655.2, filed Nov. 27, 2015, the entire teachings and disclosure of which are incorporated herein by reference thereto.

### FIELD

Exemplary embodiments of the invention relate to the normalisation of ultrasonic echo signal data, for example in order to reduce effects attributable to reflections from moving objects or effects attributable to reflections from stationary and/or quasi-stationary objects.

### BACKGROUND

Different systems are known for detecting moving and stationary objects, for example for the purpose of traffic monitoring. These systems often have stationary imaging sensors, infra-red sensors and radar sensors or a combination of these types of sensors. The use of radar sensors is expensive and complicated due to the complexity of the technology. Infra-red sensors may be disrupted by environmental light and by high environmental temperatures such that optimal results cannot exactly be achieved in an application outdoors. The use of imaging sensors is often problematic with systems outdoors for reasons of privacy law and requires high computing power in order to evaluate the sensor data. The common advantage of all the previously described methods is that they are all non-intrusive, which means that the sensors do not need to be incorporated in the road surface or similar. Intrusive sensors, such as for example induction loops, have good detection rates. The installation is, however, associated with high complexity and interference with road transport.

Ultrasonic sensors, like further non-intrusive sensors, have been used in road transport hitherto primarily in parking assistance systems of vehicles for distance measurement. In this case, it is only evaluated whether and at what distance an emitted ultrasonic pulse is initially reflected. However, such evaluations of the first reflection are not sufficient for the accurate detection of moving and stationary objects if other objects are also present in the reflection region. Ultrasonic sensors are particularly sensitive to disruptions and changes in the environments covered by the ultrasonic sensors, such as for example base reflections of the environment, the ground and stationary objects as well as movement of tree branches by the wind and similar. Ultrasonic sensors have thus not been used hitherto in systems for detecting moving and stationary objects in a complex environment.

### BRIEF SUMMARY OF SOME EXEMPLARY EMBODIMENTS OF THE INVENTION

The present invention thus has the object, inter alia, of overcoming these problems.

According to the invention, a method is disclosed, the method comprises:
Obtaining ultrasonic echo signal data, wherein the ultrasonic echo signal data at least partially represent an ultrasonic echo signal detected by an ultrasonic sensor,
Normalising the ultrasonic echo signal data, wherein normalising the ultrasonic echo signal data comprises normalising at least one first data point of the ultrasonic echo signal data at least partially as a function of at least one second data point of the ultrasonic echo signal data, wherein the first data point represents the value of the signal strength of the detected ultrasonic echo signal at a first detection time, wherein the second data point of the ultrasonic echo signal data represents the value of the signal strength of the detected ultrasonic echo signal at an earlier second detection time, wherein normalised ultrasonic echo signal data comprising the normalised first data point are obtained as a result of normalising the ultrasonic echo signal data.

The method according to the invention and/or the steps of the method according to the invention are mentioned as an example of an apparatus like the apparatus according to the invention described below.

According to the invention, a computer program is also disclosed, the computer program comprises program instructions, which cause a processor to execute and/or control the method according to the invention when the computer program runs on the processor.

The computer program according to the invention can for example be distributed via a network such as the Internet, smart city infrastructures such as the ICE Gateway distributed by the company ICE Gateway GmbH, a telephone or mobile network and/or a local network. The computer program according to the invention can be at least partially software, firmware of a processor and/or software and/or firmware of an embedded system. It may be implemented at least partially in the same manner as hardware. The computer program according to the invention can, for example be stored on a computer-readable memory medium, e.g. a tangible, magnetic, electric, electromagnetic, optical and/or other type of memory medium. The memory medium can, for example, be part of the processor, for example a (non-volatile or volatile) program memory and/or main memory of the processor or a part thereof.

According to the invention, an apparatus is also disclosed, the apparatus comprises:
means configured to perform and/or control the method according to the invention or means to perform and/or control the steps of the method according to the invention.

For example, the means of the apparatus according to the invention are configured to perform and/or control the method according to the invention or its steps (e.g. aside from the steps performed by a user). One or a plurality of the steps of the method according to the invention can also be performed and/or controlled by the same means. For example, one or a plurality of the means of the invention can be formed at least partially by one or a plurality of processors.

For example, the apparatus according to the invention has at least one circuit which is configured to prompt the apparatus to perform and/or control at least the method according to the invention and/or the steps of the method according to the invention. In this case, either all steps of the method according to the invention can be controlled, or all steps of the method according to the invention can be performed, or one or a plurality of the steps can be controlled and one or a plurality of steps can be performed.

A circuit should be understood in the present case for example as an implementation of the means of the apparatus according to the invention only in hardware and/or an implementation of the means of the apparatus according to the invention with a combination of hardware and software.

Implementation of the means of the apparatus according to the invention only in hardware comprises, for example, digital and/or analogue circuits (e.g. exclusively digital and/or analogue circuits) such as a configurable digital logic. For example, the apparatus according to the invention comprises at least one digital and/or analogue circuit which is configured to prompt the apparatus to perform and/or control at least the method according to the invention and/or the steps of the method according to the invention.

Implementation of the means of the apparatus according to the invention with a combination of hardware and software comprises, for example, at least one processor and at least one memory with program instructions. For example, the apparatus according to the invention has a processor and at least one memory, which contains program code, wherein the memory and the program code are configured to prompt the apparatus together with at least one processor, to perform and/or control at least the method according to the invention and/or the steps of the method according to the invention. A processor should, for example, be understood as a control unit, a microprocessor, a microcontrol unit such as a microcontroller, a digital signal processor (DSP, Digital Signal Processor), an application-specific integrated circuit (ASIC, Application-Specific Integrated Circuit) or a Field Programmable Gate Array, FPGA).

According to the invention, a system is also disclosed, the system comprises:
one or a plurality of apparatuses according to the invention, and
one or a plurality of stationary ultrasonic sensors.

The properties of the method according to the invention, of the computer program according to the invention, of the apparatus according to the invention and of the system according to the invention are, partially by way of example, described below.

An ultrasonic echo signal should for example be understood to mean an ultrasonic signal which is detected by an ultrasonic sensor and at least substantially comprises signal portions attributable to reflections (for example signal portions attributable to reflections of one or more ultrasonic pulses from objects). The ultrasonic echo signal is detected by the ultrasonic sensor, for example by measuring the signal strength of the ultrasonic echo signal. For example, the ultrasonic sensor is formed as an ultrasonic detector. For example, the signal strength of an ultrasonic echo signal detectable at the position of the ultrasonic sensor can be detected and/or measured indirectly by a piezoelectric transducer encompassed by the ultrasonic sensor. For example, the piezoelectric transducer converts the ultrasonic echo signal into an electric signal. For example, the value of the signal strength of the ultrasonic echo signal can be determined by the measurement of the voltage amplitude of this electric signal. The ultrasonic echo signal data can, for example, be obtained by an analogue-digital converter of this electric signal.

The ultrasonic echo signal data are, for example, a representation of the time curve of the signal strength of the ultrasonic echo signal detected by the ultrasonic sensor. The ultrasonic echo signal data are preferably a digital representation of the time curve of the signal strength of the ultrasonic echo signal detected by the ultrasonic sensor.

A data point of the ultrasonic echo signal data comprises, for example, a representation (e.g. a digital representation) of the value of the signal strength of the ultrasonic echo signal detected by the ultrasonic sensor at a determined detection time. Such a data point can, for example, also comprise a representation (e.g. a digital representation) of the detection time. Alternatively or additionally, the detection time can also emerge from the position of the data point in the ultrasonic echo signal data.

Obtaining the ultrasonic echo signal data comprises, for example, measuring the signal strength of the ultrasonic echo signal and/or determining the value of the signal strength or further information of the ultrasonic echo signal. In this case, the ultrasonic sensor is, for example, a part of the apparatus according to the invention.

Alternatively or additionally, obtaining the ultrasonic echo signal data can also comprise obtaining the ultrasonic echo signal data from the ultrasonic sensor. In this case, the ultrasonic sensor is, for example, not part of the apparatus according to the invention. In this case, the ultrasonic echo signal data are, for example, communicated from the ultrasonic sensor to the apparatus according to the invention. For example, the apparatus according to the invention comprises communication means which are configured to obtain the ultrasonic echo signal data from the ultrasonic sensor.

An example of such communication means is a communication interface, for example a wireless communication interface such as a communication interface of wireless communication technology or a wired communication interface such as a communication interface of wired communication technology. An example of wireless communication technology is Zigbee, 6LOWPAN, a local radio network such as Radio Frequency Identification (RFID) and/or Near Field Communication (NFC) and/or Bluetooth (e.g. Bluetooth Version 2.1 and/or 4.0) and/or Wireless Local Area Network (WLAN). RFID and NFC- are, for example, specified according to the ISO-Standards 18000, 11784/11785 and the ISO/IEC-Standard 14443-A and 15693. The Bluetooth specifications are currently available on the internet at www[dot]bluetooth[dot]org. WLAN is specified for example in the standards of IEEE-802.11 family. A further example of wireless communication technology is regional radio technology such as for example a mobile network, for example, Global System for Mobile Communications (GSM) and/or Universal Mobile Telecommunications System (UMTS) and/or Long Term Evolution (LTE). GMS, UMTS and LTE specifications are supported and developed by the 3rd Generation Partnership Project (3GPP) and are currently available on the internet at www[dot]3gpp[dot]com. An example of wired communication technology is, for example, Ethernet, USB (Universal Serial Bus), Firewire, UART (Universal Asynchronous Receiver Transmitter) such as RS-232, SPI (Serial Peripheral Interface) and/or I2C (Inter-Integrated Circuit) and/or Power over Ethernet (PoE). The USB specifications are currently available on the internet at www[dot]usb[dot]org. A wired Ethernet communication interface could, at the same time, also be used for the energy supply of the apparatus according to the invention and/or the ultrasonic sensor in the context of technology designated as PoE (Power over Ethernet). PoE is, for example, specified in the IEEE-Standard 802.3af-2003. However, later and future versions of this standard or proprietary modifications should also be understood under the term PoE. PoE can, for example, be used both for the energy supply of the apparatus according to the invention and/or of the ultrasonic sensor and also as communication technology for communicating information and/or data between the apparatus according to the invention and the ultrasonic sensor.

Normalising the ultrasonic echo signal data should, for example, be understood according to a first aspect of the invention to the effect that signal portions attributable to reflections of one or a plurality of previously emitted ultrasonic pulses from stationary and/or quasi-stationary objects are at least partially reduced in the normalised ultrasonic echo signal represented by the normalised ultrasonic echo signal data according to the first aspect of the invention in comparison with the detected ultrasonic echo signal. Accordingly, according to this first aspect of the invention the method according to the invention and the apparatus according to the invention serve, for example, to reduce effects attributable to reflections from stationary and/or quasi-stationary objects, for example to reduce signal portions attributable to reflections of one or more previously emitted ultrasonic pulses from stationary and/or quasi-stationary objects in an ultrasonic echo signal represented by ultrasonic echo signal data.

According to a second aspect of the invention, in the present case the normalisation of the ultrasonic echo signal data should for example be understood to mean that signal portions attributable to reflections of one or more previously emitted ultrasonic pulses from moving objects should be at least partially reduced in the normalised ultrasonic echo signal represented by the normalised ultrasonic echo signal data according to the second aspect the invention in comparison with the detected ultrasonic echo signal. Accordingly, according to this second aspect of the invention the method according to the invention and the apparatus according to the invention serve, for example, to reduce effects attributable to reflections from moving objects, for example to reduce signal portions attributable to reflections of one or more previously emitted ultrasonic pulses from moving objects in an ultrasonic echo signal represented by ultrasonic echo signal data.

By combining the first and second aspect, the signal portions attributable to reflections from stationary and/or quasi-stationary objects and reflections from moving objects can be separated from each other.

Normalising at least the first data point of the ultrasonic echo signal data according to the first and the second aspect of the invention takes place, for example, by determining a normalised first data point based on at least the first data point and the second data point. For example, a representation of a value of a signal strength encompassed by the normalised first data point is determined based on the values of the signal strength of the detected ultrasonic echo signal represented by the first data point and the second data point. As a result of normalising the ultrasonic echo signal data, normalised echo signal data are, for example, obtained which comprise at least the normalised first data point.

According to the first aspect of the invention, the second data point can for example be determined and/or selected as a function of the first data point such that signal portions attributable to reflections of one or more previously emitted ultrasonic pulses from stationary and/or quasi-stationary objects are at least partially reduced in the ultrasonic echo signal represented by the normalised ultrasonic echo signal data in comparison with the detected ultrasonic echo signal. For example, the second data point is correspondingly determined and/or selected as a function of the first data point. Stationary objects should for example thereby be understood to mean objects which are located in the same position at the first detection time and at the second detection time. Examples of such stationary objects in the environment of an ultrasonic sensor are for example one or more ground surfaces, houses, trees and parked vehicles. Quasi-stationary objects are for example objects which are substantially located in the same position at the first detection time and at the second detection time. These can for example be branches of a tree moving slightly in the wind and/or a window of a house being opened. Signal portions of the ultrasonic echo signal represented by the ultrasonic echo signal data attributable to reflections from such stationary and/or quasi-stationary objects interfere, for example, with the detection of moving objects such as moving cars, cyclists or pedestrians. The normalisation of the ultrasonic echo signal data according to the first aspect of the invention is thus, inter alia, advantageous in order to facilitate and/or make possible the detection of such moving objects through provision of the normalised ultrasonic echo signal data, even if the first reflection comes for example from a stationary object.

According to the second aspect of the invention, the second data point can for example be determined and/or selected as a function of the first data point such that signal portions attributable to reflections of one or more previously emitted ultrasonic pulses from moving objects are at least partially reduced in the ultrasonic echo signal represented by the normalised ultrasonic echo signal data in comparison with the detected ultrasonic echo signal. For example, the second data point is correspondingly determined and/or selected as a function of the first data point. Moving objects should for example thereby be understood to mean objects which are located in different positions at the first detection time and at the second detection time. Examples of such moving objects in the environment of an ultrasonic sensor are for example moving vehicles, cyclists, pedestrians, etc. Signal portions of the ultrasonic echo signal represented by the ultrasonic echo signal data attributable to reflections from such moving objects interfere, for example, with the detection of parked vehicles. The normalisation of the ultrasonic echo signal data according to the second aspect of the invention is thus, inter alia, advantageous in order to facilitate and/or make possible the detection of such stationary objects through provision of the normalised ultrasonic echo signal data, even if the first reflection comes for example from a moving object.

Alternatively or additionally, the normalised ultrasonic echo signal data according to the second aspect of the invention can for example be obtained by determining the difference between the normalised ultrasonic echo signal data according to the first aspect of the invention and the ultrasonic echo signal data which represent the ultrasonic echo signal detected by the ultrasonic sensor. Conversely, the normalised ultrasonic echo signal data according to the first aspect of the invention can for example also be obtained by determining the difference between the normalised ultrasonic echo signal data according to the second aspect of the invention and the ultrasonic echo signal data which represent the ultrasonic echo signal detected by the ultrasonic sensor.

The present invention is for example advantageous in order to be able at least substantially to reduce interfering signal portions (for example reflections attributable to moving or stationary/quasi-stationary objects) in a detected ultrasonic echo signal, so that the evaluation of the ultrasonic echo signal with respect to reflections from different objects is facilitated and/or made possible and is not limited to the evaluation of the first reflection. This has for example the effect that the detection range of an ultrasonic sensor can be increased, for example it allows an ultrasonic sensor to be used simultaneously to monitor traffic (moving objects) and to monitor parking spaces of one or more parking areas (stationary objects).

Additional advantages of the disclosed invention are described below based on exemplary embodiments of the method according to the invention, of the computer program according to the invention, of the apparatus according to the invention and of the system according to the invention, whose disclosure should apply in equal measure to the respective categories (method, computer program, apparatus, system). Unless otherwise described in the following, these exemplary embodiments also apply in equal measure to all aspects the invention.

According to an exemplary embodiment of the invention, the normalisation at least of the first data point also takes place at least partially as a function of one or more additional data points of the ultrasonic echo signal data, wherein each of the additional data points represents the value of the signal strength of the detected ultrasonic echo signal at a respective further detection time earlier than the second detection time or at a respective further detection time later than the first detection time.

According to an exemplary embodiment of the invention, the ultrasonic sensor is stationary. In this case, stationary should, for example be understood as the ultrasonic sensor being permanently located at a determined position (e.g. a geographic and/or spatial position). For example, the ultrasonic sensor is permanently installed and/or mounted at this position. For example, the ultrasonic sensor is installed and/or mounted in a sidefire configuration (for example in an angular orientation, for example oriented at an angle to the detection region and/or to a ground surface, for example the earth's surface within the detection range). This has the effect of the detection range of the ultrasonic sensor covering a larger region than for example with a perpendicular alignment to the detection region and/or to a base surface.

Exemplary embodiments are also possible in which the ultrasonic sensor is pivotable. For example, the ultrasonic sensor is mechanically pivotable and/or the detection direction of the ultrasonic sensor is electrically pivotable (e.g. by a phased array receiver arrangement). The ultrasonic sensor is, for example, not part of a transportable apparatus (e.g. of a vehicle) in any of these exemplary embodiments. The ultrasonic sensor is, for example, not part of a transportable apparatus (e.g. of a vehicle) in any of these exemplary embodiments.

The ultrasonic sensor may, for example, be part of a plurality of ultrasonic sensors, for example part of an ultrasonic sensor array. For example, the system according to the invention comprises such a plurality of ultrasonic sensors.

For example, a plurality of ultrasonic sensors can be arranged such that they asynchronously detect an ultrasonic echo signal, for example by a sequence of ultrasonic sensors detecting the ultrasonic echo signal in time periods following each other chronologically. The results from ultrasonic sensor to ultrasonic sensor may, for example, be thereby further optimised.

According to one exemplary embodiment of the invention, the method according to the invention also comprises emitting and/or prompting the emitting of one or a plurality of ultrasonic pulses.

For example, the emitted ultrasonic pulses are based on a time-limited prototype pulse, which is modulated and/or frequency-shifted to an ultrasonic carrier frequency (e.g. 44 kHz).

For example, the ultrasonic pulses are emitted at regular time intervals such that the time difference between the emission times of two consecutive ultrasonic pulses is always the same. In this case, an emission time of an ultrasonic pulse should, for example, be understood as the period at which the emission of the ultrasonic pulse starts. The ultrasonic pulses are, for example, also equal and/or the ultrasonic pulses have, for example, the same pulse length. However, the ultrasonic pulses can also be unequal and/or be emitted at irregular time intervals and/or with different pulse lengths. Embodiments are also possible in which the time intervals are changeable between two consecutive ultrasonic pulses and/or the pulse length of the ultrasonic pulses.

For example, the ultrasonic pulses are emitted by the ultrasonic sensor. In this case, the ultrasonic sensor is, for example, formed as a combined ultrasonic emitter and ultrasonic detector.

Embodiments are also possible in which the ultrasonic pulses are emitted from a correspondingly configured ultrasonic emitter separate to the ultrasonic sensor. For example, the ultrasonic emitter is stationary. In this case, stationary should, for example be understood, as described above concerning the ultrasonic sensor, as the ultrasonic emitter being permanently located at a determined position. For example, the ultrasonic emitter is permanently installed and/or mounted at this position. For example, the ultrasonic emitter is installed and/or mounted in a sidefire configuration (for example in an angular orientation, for example oriented at an angle to a ground surface, for example the earth's surface). Embodiments are also possible in which the ultrasonic emitter is pivotable. For example, the ultrasonic sensor is mechanically pivotable and/or the detection direction of the ultrasonic sensor is electrically pivotable (e.g. by a phased array receiver arrangement). The ultrasonic sensor is, for example, not part of a transportable apparatus (e.g. of a vehicle) in any of these exemplary embodiments. The ultrasonic emitter is, for example, not part of a transportable apparatus (e.g. of a vehicle) in any of these embodiments.

For example, the apparatus according to the invention comprises the ultrasonic emitter.

Alternatively or additionally, the apparatus according to the invention can, for example, actuate the ultrasonic emitter in order to prompt the emitting of the ultrasonic pulses by the ultrasonic emitter. For example, the apparatus according to the invention comprises communication means which are configured to communicate a corresponding actuation signal to the ultrasonic emitter. An example of such communication means, as explained above, is a communication interface, for example a wireless communication interface or a wired communication interface.

An ultrasonic emitter comprises, for example a piezoelectric transducer which, for example converts an electric signal into an ultrasonic pulse.

The ultrasonic emitter (and/or the ultrasonic sensor formed as a combined ultrasonic sensor and ultrasonic detector) can, for example be part of a plurality of ultrasonic emitters (and/or ultrasonic sensors), for example part of an ultrasonic emitter array (and/or ultrasonic sensor array). For example, the system according to the invention comprises such a plurality of ultrasonic emitters (and/or ultrasonic sensors).

Every ultrasonic pulse emitted from another ultrasonic emitter of a plurality of ultrasonic emitters and/or another ultrasonic sensor of a plurality of ultrasonic sensors has, for example a different ultrasonic carrier frequency. This has the effect of signal portions in an ultrasonic echo signal attributable to reflections from ultrasonic pulses of different ultrasonic emitters and/or ultrasonic sensors, for example, being able to at least substantially be separated by band-pass filtering.

Accordingly, the method according to the invention can, for example, comprise such band-pass filtering of the ultrasonic echo signal detected by the ultrasonic sensor. Alternatively or additionally, the ultrasonic echo signal data obtained can, for example, represent a correspondingly band-filtered ultrasonic echo signal which comprises signal portions attributable at least substantially to reflections of ultrasonic pulses of a single ultrasonic emitter.

According to an exemplary embodiment of the invention the ultrasonic echo signal comprises signal portions which are attributable to reflections of one or more of the previously emitted ultrasonic pulses from objects in the environment of the ultrasonic sensor.

According to an exemplary embodiment of the invention, the first detection time and the second detection time are in each case associated with the same signal runtime of a previously emitted ultrasonic pulse. Preferably, the first detection time and the second detection time are in each case associated with the same signal runtime of an ultrasonic pulse of the ultrasonic pulses emitted immediately before the respective detection time. For example, the second data point can be determined and/or selected such that the second detection time is associated with the same signal runtime of a previously emitted ultrasonic pulse (for example of the ultrasonic pulse of the ultrasonic pulses emitted immediately before the respective detection time) as the first detection time. For example, the second data point is determined and/or selected in this way.

The signal runtime should, for example, be understood as the time difference between the emission time of an ultrasonic pulse and the detection time of the signal portions in an ultrasonic echo signal attributable to reflections of the ultrasonic pulse. A detection time should, for example be understood as being associated with a signal runtime when the time difference between the detection time and an emission time of a previously emitted ultrasonic pulse corresponds to the signal runtime. This embodiment is, for example, advantageous if the ultrasonic pulses are emitted from a stationary ultrasonic emitter and/or stationary ultrasonic sensor and the ultrasonic echo signal is detected by a stationary ultrasonic sensor since, in such a case, signal portions of the detected ultrasonic echo signal attributable to reflections of an ultrasonic pulse from stationary objects in each case cover the same distance from the ultrasonic emitter and/or the ultrasonic sensor to the ultrasonic sensor and thus have the same signal runtime.

For example, the time difference between the first detection time and the second detection time corresponds to the time difference between the emission times of two consecutive ultrasonic pulses or a whole multiple of the time difference between the emission times of two consecutive ultrasonic pulses. For example, the time difference between the first detection time and the second detection time corresponds to the time difference between the emission times of two consecutive ultrasonic pulses. Accordingly, the time difference between the first detection time and each of the further detection times also for example corresponds to the time difference between the emission times of two consecutive ultrasonic pulses or a whole multiple of the time difference between the emission times of two consecutive ultrasonic pulses. This has for example the effect that, if the time difference between the emission times of two consecutive ultrasonic pulses is always equal, each of these detection times is associated with the same signal runtime. This makes possible a simple determination and/or selection of the second data point and any additional data points.

If an ultrasonic pulse is emitted by an ultrasonic emitter and/or an ultrasonic sensor which is part of the apparatus according to the invention and/or is actuated by the apparatus according to the invention, the apparatus according to the invention knows the emission time of the ultrasonic pulse or can determine this.

Alternatively or additionally, corresponding emission time data, which represent one or a plurality of emission times of one or a plurality of ultrasonic pulses, can be received by the apparatus according to the invention and/or stored in a memory of the apparatus according to the invention. For example, the emission time data are received by the apparatus according to the invention from the ultrasonic emitter and/or the ultrasonic sensor. For example, the apparatus according to the invention comprises communication means which are configured to receive emission time data from the ultrasonic emitter and/or the ultrasonic sensor. An example of such communication means, as described above, is a communication interface, for example a wireless communication interface or a wired communication interface.

According to an exemplary embodiment of the invention, normalising at least the first data point comprises at least one of:
determining a signal strength average value at least as a function of the values of the signal strength of the ultrasonic echo signal represented by the first data point and the second data point;
determining a signal strength standard deviation and/or a signal strength variance at least partially as a function of the values of the signal strength of the detected ultrasonic echo signal represented by the first data point and the second data point;
dividing the signal strength average value by the signal strength standard deviation;
subtracting the signal strength average value from the value of the signal strength of the detected ultrasonic echo signal represented by the first data point; and
dividing the result of the subtraction of the signal strength average value from the value of the signal strength of the detected ultrasonic echo signal represented by the first data point by the signal strength standard deviation.

For example, the average signal strength value and/or the signal strength deviation are determined at least as a function of a sample comprising at least the values of the signal strength of the detected ultrasonic echo signal represented by the first data point and the second data point. Furthermore, the sample can for example comprise the values of the signal strength of the detected ultrasonic echo signal represented by the additional data points. The values contained in the sample can for example be weighted, for example as a function of a time-dependent window function. The time-dependent window function can also, for example, at least partially specify the size of the sample and/or the data points to be taken into consideration. For example, the window function specifies a time window within which the second data point and any additional data points lie.

For example, the average signal strength value is determined by calculating the arithmetic average of the values contained in the sample. For example, the signal strength standard deviation is determined by calculating the standard deviation in the values contained in the sample. For example, the signal strength variance is determined by calculating the variance in the values contained in the sample.

As a result of dividing the average signal strength value by the signal strength standard deviation, the normalised first data point according to the second aspect of the invention is for example obtained. This has the effect that the values of the signal strength of the detected ultrasonic echo signal represented on average by the first data point and the second data point and any additional data points can be taken into consideration in the determination of the normalised first data point according to the second aspect of the invention. If each of these data points is in each case associated with the same signal runtime of an ultrasonic pulse of the ultrasonic pulses emitted immediately before the respective detection time, these averaged values of the signal strength of the detected ultrasonic echo signal correspond for example to the signal portion attributable on average to the reflection of the emitted ultrasonic pulses at a particular distance from the ultrasonic sensor. Such a reflection, which always takes place at the same distance from the ultrasonic sensor, is in all probability attributable to a reflection from a stationary object. Accordingly, by taking into consideration the average signal strength value as a factor and/or dividend in the determination of at least the first data point according to the second aspect of the invention, the signal portions in the normalised ultrasonic echo signal represented by the normalised ultrasonic echo signal data attributable to reflections of one or more previously emitted ultrasonic pulses from moving objects according to the second aspect of the invention can be at least partially reduced in comparison with the detected ultrasonic echo signal.

The normalised first data point according to the first aspect of the invention is for example obtained as a result of dividing the result of the subtraction of the average signal strength value from the value of the signal strength of the detected ultrasonic echo signal represented by the first data point by the signal strength standard deviation. Alternatively, it is for example also conceivable that the normalised first data point according to the first aspect of the invention is obtained as result of the subtraction of the average signal strength value from the value of the signal strength of the detected ultrasonic echo signal represented by the first data point. As explained above, the average signal strength value corresponds for example to the average signal portion attributable to a reflection of the emitted ultrasonic pulses at a particular distance from the ultrasonic sensor. Through the subtraction of the average signal strength value from the value of the signal strength of the detected ultrasonic echo signal represented by the first data point, this average signal portion is for example reduced and/or removed, so that, by taking into consideration the average signal strength value as subtrahend in the determination of at least the first data point according to the first aspect of the invention, the signal portions in the normalised ultrasonic echo signal represented by the normalised ultrasonic echo signal data according to the first aspect of the invention attributable to reflections of one or more previously emitted ultrasonic pulses from stationary and/or quasi-stationary objects can be at least partially reduced in comparison with the detected ultrasonic echo signal. According to an exemplary embodiment of the invention, as result of the normalisation, normalised ultrasonic echo signal data according to the first aspect of the invention and normalised ultrasonic echo signal data according to the second aspect of the invention are obtained.

In the normalised ultrasonic echo signal represented by the normalised ultrasonic echo signal data according to the first aspect of the invention, the signal portions attributable to reflections of one or more previously emitted ultrasonic pulses from stationary and/or quasi-stationary objects are for example at least partially reduced in comparison with the detected ultrasonic echo signal.

In the normalised ultrasonic echo signal represented by the normalised ultrasonic echo signal data according to the second aspect of the invention, the signal portions attributable to reflections of one or more previously emitted ultrasonic pulses from moving objects are for example at least partially reduced in comparison with the detected ultrasonic echo signal.

According to an exemplary embodiment of the invention, the normalisation is carried out for each data point of the ultrasonic echo signal data. For example, the above-described normalising of at least the first data point is repeated for each data point of the ultrasonic echo signal data. For example, the first data point is in each case the data point which is to be normalised. For example, the second data point (and if necessary each of the additional data points) is in each case determined and/or selected as a function of the first data point.

According to an exemplary embodiment of the invention, the method according to the invention further comprises dividing the ultrasonic echo signal data into a plurality of ultrasonic echo signal data blocks, wherein the ultrasonic echo signal data blocks represent consecutive time periods of identical time period length of the time curve of the value of the signal strength of the detected ultrasonic echo signal, and wherein a first ultrasonic echo signal data block comprises the first data point and a second ultrasonic echo signal data block comprises the second data point.

For example, each of the time periods starts with the emission time of an ultrasonic pulse. The time period length of each of the time periods also, for example, corresponds to the time difference between the emission times of two consecutive ultrasonic pulses. This has, for example, the effect that the time curve of the signal strength of the detected ultrasonic echo signal and/or of the normalised ultrasonic echo signal represented by an ultrasonic echo signal data block is determined at least substantially by reflections of the ultrasonic pulse emitted at the start of the respective time period and is thus also denoted below, by way of example, as an ultrasonic pulse response.

This also, for example allows data points, which are located at the same position in different ultrasonic echo signal data blocks to be associated with the same signal runtime (based on the emission time at the start of the respective time period) when the time difference between the emission times of two consecutive ultrasonic pulses is always the same. This facilitates for example the determination and/or the selection of the second data point. For example, the second data point is determined and/or selected such that the second data point in the second ultrasonic echo signal data block is located at the same position as the first data point in the first ultrasonic echo signal data block. Accordingly, any additional data points can also be determined and/or selected such that they are located in the same position in their respective ultrasonic echo signal data block as the first data point is located in the first ultrasonic echo signal data block.

According to an exemplary embodiment of the invention, the method according to the invention further comprises the determination of a graphic representation of the ultrasonic echo signal data and/or the normalised ultrasonic echo signal data at least partially as a function of the ultrasonic echo signal data blocks.

As a result of determining the graphic representation, an ultrasonic echo signal data structure that can be graphically represented is, for example, obtained, such as a two-dimensional data field and/or a data array and/or a graphic file (e.g. a graphic file in an image data format such as the bitmap format, BMP format).

The graphic representation is, for example, a graphic interpretation and/or abstraction of the ultrasonic echo signal data.

For example, the graphic representation is and/or comprises a pixel arrangement with pixels arranged in a grid (e.g. the ultrasonic echo signal data structure obtained as a result of determining the graphic representation can be represented as a pixel arrangement). For example, each pixel of the pixel arrangement is determined as a function of a data point of the ultrasonic echo signal data and/or the normalised ultrasonic echo signal data. For example, the colour, shading and/or grey scale of a pixel is determined as a function of the value of the signal strength represented by the respective data point.

For example, adjacent pixels in a grid column of the grid, are, for example, determined by consecutive data points of a respective ultrasonic echo signal data block of the ultrasonic echo signal data blocks; and adjacent pixels in a grid row of the grid are, for example, determined by data points, which are located in consecutive ultrasonic echo signal data blocks (e.g. located at the same position in consecutive ultrasonic echo signal data blocks). This has for example the effect that, if each of the time periods represented by the ultrasonic echo signal data blocks begins with the emission time of an ultrasonic pulse and the time period length of each of the time periods corresponds for example to the time difference between the emission times of two consecutive ultrasonic pulses, the pixels of a grid column are at least substantially determined through reflections of the ultrasonic pulse emitted at the beginning of the respective time period.

Reflections from moving and/or stationary objects can thus be recognised and analysed simply. For example, image processing algorithms (e.g. clustering algorithms and/or algorithms for object and/or pattern recognition) can be used to recognise reflections from moving and/or stationary objects. Also, the graphic representation enables a human observer to recognise and/or analyse reflections from moving and/or stationary objects.

Ultimately, moving and/or stationary objects can be recognised through the detection and analysis of reflections from moving and/or stationary objects.

According to an exemplary embodiment of the invention, the method according to the invention further comprises the evaluation of the ultrasonic echo signal data, at least partially based on the normalised ultrasonic echo signal data. Optionally, the method according to the invention can further comprise the output of a control signal at least partially based on the result of the evaluation.

The evaluation can for example be carried out by the apparatus according to the invention and/or by one or more further devices. These devices can for example consist of a server, for example a cloud and/or backend server and/or one or more further apparatuses according to the invention. For example, the method according to the invention further comprises communicating the ultrasonic echo signal data and/or the normalised ultrasonic echo signal data at least partially to one or more further devices for evaluation. For example, the apparatus according to the invention comprises correspondingly configured communication means. An example of such communication means, as described above, is a communication interface, for example a wireless communication interface or a wired communication interface.

For example, the evaluation comprises the determination of amplitude, frequency and/or phase information of the ultrasonic echo signal represented by the ultrasonic echo signal data and/or the normalised ultrasonic echo signal represented by the normalised ultrasonic echo signal data.

The evaluation can for example comprise the application at least of an image processing algorithm and/or clustering algorithm to the graphic representation of the normalised ultrasonic echo signal data and/or to a graphically representable ultrasonic echo signal data structure obtained as result of the determination of the graphic representation. An example of an application of an image processing algorithm is for example an application of a two-dimensional filter (for example of a two-dimensional Hamming filter) to the graphic representation of the normalised ultrasonic echo signal data and/or the graphically representable ultrasonic echo signal data structure. An example of a clustering algorithm is for example the DBSCAN (Density-Based Spatial Clustering of Applications with Noise) algorithm, or a modified DBSCAN algorithm.

Characteristic data such as characteristic properties and values of the respective clusters can then be determined. Examples of such cluster characteristic data are information on the localisation, distribution, form, energy, extent and distance of the signal portions of the ultrasonic echo signal represented by the normalised ultrasonic echo signal data attributable to reflections from objects represented by a cluster. These cluster characteristic data make possible for example a description and examination of backscatter patterns. Further examples of cluster characteristic data are frequency and/or phase information.

The evaluation can for example comprise the merging of the ultrasonic echo signal data with further ultrasonic echo signal data, wherein the further ultrasonic echo signal data represent for example the change over time of the signal strength of a further ultrasonic echo signal detected by a further ultrasonic sensor. If necessary, the merging of the ultrasonic echo signal data can also take place with further ultrasonic echo signal data which represent the change over time of the signal strength of one or more ultrasonic sensors. For example, ultrasonic echo signal data from different ultrasonic sensors can be taken into consideration. Alternatively or additionally, the further ultrasonic echo signal data can for example represent the change over time of the signal strength of at least one further ultrasonic echo signal which at least substantially comprises signal portions attributable to reflections of ultrasonic pulses from another ultrasonic emitter and/or ultrasonic sensor.

For example, the evaluation comprises the merging of the normalised ultrasonic echo signal data with normalised further ultrasonic echo signal data, wherein, in the ultrasonic echo signal represented by the normalised further ultrasonic echo signal data, signal portions attributable to reflections of one or more ultrasonic pulses from stationary bodies are at least partially reduced in comparison with the further ultrasonic echo signal detected by the further ultrasonic sensor. Alternatively or additionally, the evaluation comprises the merging of the cluster characteristic data and/or signal properties of the respective ultrasonic echo signal data and/or normalised ultrasonic echo signal data.

Merging the ultrasonic echo signal data with further ultrasonic echo signal data should, for example, be understood as the ultrasonic echo signal data being compared, combined and/or augmented with the further ultrasonic echo signal data. Accordingly, merging of the normalised ultrasonic echo signal data with normalised further ultrasonic echo signal data should for example be understood to the effect that the normalised ultrasonic echo signal data are compared, combined and/or augmented with the normalised further ultrasonic echo signal data. The cluster characteristic data and/or signal properties of the respective ultrasonic echo signal data and/or normalised ultrasonic echo signal data are for example correspondingly merged through comparison, combination and/or augmentation.

The merged ultrasonic echo signal data can for example be analysed with respect to differences in amplitude, signal runtime, phase and frequency and/or different cluster characteristic data.

The evaluation can for example comprise the recognition of moving and/or stationary objects within the detection range of the ultrasonic sensor at least partially based on the normalised ultrasonic echo signal data and/or the determined cluster characteristic data and/or the differences in amplitude, signal runtime, phase and frequency and/or different cluster characteristic data of the merged ultrasonic echo signal data. For example, moving and stationary objects within the detection range of the ultrasonic sensor can be recognised at least partially based on a comparison of the ultrasonic echo signal data and the normalised ultrasonic echo signal data (for example through a comparison of the normalised ultrasonic echo signal data according to the first aspect of the invention with the normalised ultrasonic echo signal data according to the second aspect of the invention). The frequency and/or phase information can for example be used to determine a motion vector of a moving object.

A possible application (of the first aspect of the invention) for the recognition of moving objects is for example traffic counting and/or monitoring. A possible application (of the second aspect of the invention) for the recognition of stationary objects is for example parking space monitoring. In both application cases, the present invention is particularly advantageous since, in contrast to the prior art, it makes possible not only the evaluation of the first reflection of an ultrasonic pulse, but for example the evaluation of the entire pulse response, so that a significantly larger area (for example several traffic lanes and/or parking spaces) can be scanned and monitored. By reducing the effects attributable to reflections from moving objects (according to the second aspect of the invention) or stationary and/or quasi-stationary objects (according to the first aspect of the invention), depending on the application, interfering signal portions can be at least substantially removed.

It should be understood that the evaluation can also be carried out independently of the normalisation of the ultrasonic echo signal data. For example, the evaluation can only be carried out on the basis of the received ultrasonic echo signal data.

The result of the evaluation can for example be communicated at least partially to one or more further devices. These devices can for example comprise a server, for example a cloud and/or backend server, and/or one or more further apparatuses according to the invention and/or a control device (for example a control device for controlling a lighting means such as an ICE Gateway distributed by the company ICE Gateway GmbH). For example, the apparatus according to the invention comprises communication means which are configured to communicate the result of the evaluation. An example of such communication means, as described above, is a communication interface, for example a wireless communication interface or a wired communication interface.

An example of such communication means is, as described above, a communication interface, for example a wireless communication interface or a wired communication interface. It is understood that the control signal may depend at least partially on different results and/or events (e.g. on signals detected by different sensors and/or different sensor types). Such a control signal can, for example, serve to actuate an actuator (e.g. a lighting means and/or a camera). For example, the actuator can be activated by the control signal if a moving object is detected. For example, the actuator is part of the apparatus according to the invention. However, embodiments are also possible in which the actuator is separate from the apparatus according to the invention. For example, the apparatus according to the invention comprises communication means which are configured to communicate the control signal to the actuator. An example of such communication means, as described above, is a communication interface, for example a wireless communication interface or a wired communication interface.

Such an actuator is, for example, a lighting means and/or a control apparatus for controlling a lighting means.

According to one exemplary embodiment of the invention, the apparatus according to the invention is a control apparatus for controlling a lighting means, comprises a control apparatus for controlling a lighting means and/or is part of a control apparatus for controlling a lighting means. For example, the apparatus according to the invention comprises means which are configured to control one or a plurality of lighting means. The control can for example take place at least partially depending on the result of the evaluation of the ultrasonic echo signal data and/or the normalised ultrasonic echo signal data. An example of such a control apparatus is, for example, a control apparatus for a traffic light and/or one or a plurality of streetlamps.

Such a control apparatus for controlling a lighting means of a lamp outdoors is, for example described in the patent application with the file reference DE 10 2014 102 678.0 to which explicit reference is made here. Such an apparatus is, for example, also an apparatus manufactured by the company, ICE Gateway under the product name ICE Gateway.

Controlling a lighting means (e.g. a lighting means connected to the apparatus) should, for example, be understood as switching on, switching off and/or dimming the lighting means.

For example, the apparatus according to the invention also comprises one or a plurality of energy supply means. For example, the energy supply means are configured to be connected to the lighting means and to supply the lighting means with energy and/or to provide current to operate the lighting means. For example, the lighting means are controlled by the energy supply means being controlled. For example, the energy supply means comprise a converter, a controllable driver circuit and/or a controllable voltage transformer (e.g. a controllable direct voltage transformer).

The lighting means is preferably a direct current-based lighting means. For example, the lighting means is an LED lighting means (Light Emitting Diode) and/or an OLED lighting means (Organic Light Emitting Diode). The lighting means can, however, also be an alternating current-based lighting means. For example, the lighting means is a bulb and/or a gas discharge lamp.

For example, the lighting means are controlled at least partially depending on the result of the evaluation of the ultrasonic echo signal data and/or the normalised ultrasonic echo signal data. For example, the lighting means are switched on or brightened in response to certain results of the evaluation and switched off or dimmed in response to other results of the evaluation.

As a result, an apparatus for controlling a lighting means is, for example, provided with additional functions such as normalisation of the ultrasonic echo signal data. This is, for example, advantageous since no additional installation effort has to be spent, for example, for the provision of additional functions and the means of the apparatus already present can be used for controlling the lighting means. Such apparatuses for controlling a lighting means are typically also part of a lighting system (e.g. a light system of a city) which comprises a plurality of apparatuses for controlling a lighting means such that a larger public area can be covered.

For example, the apparatus according to the invention can be arranged or is arranged on or in a lamp outdoors, in particular a streetlamp. For example, the apparatus according to the invention is part of a lighting apparatus such as a lamp, for example a lamp outdoors, in particular a streetlamp and/or a lamp of a traffic light.

Arranged on or in a lamp outdoors should, for example, be understood as the apparatus according to the invention being arranged inside the lamp (e.g. in the lamp head or in the mast) and/or on the housing of the lamp (e.g. on the lamp head and/or on the mast). For example, the apparatus according to the invention is arranged in the light, on or at the light, in the lamp and/or at the lamp.

According to an exemplary embodiment of the invention, the apparatus according to the invention is arranged and/or mounted on or at a bus stop, on a platform, on or in a public space, on or in a public building (for example on an entrance and/or exit door) in order to measure the inflow of visitors.

According to one exemplary embodiment of the invention, the system according to the invention also comprises one or a plurality of control apparatuses for controlling a lighting means. It is understood that the system according to the invention can, alternatively or additionally, comprise additional external components (e.g. sensors, servers and/or apparatuses).

According to one exemplary embodiment of the invention, the system according to the invention is a lighting system (e.g. of a city).

Further advantageous exemplary configurations of the invention can be inferred from the following detailed description of a number of exemplary embodiments of the present invention, in particular in combination with the figures. However, the figures enclosed with the application are only intended to be used for illustration purposes and not to define the scope of protection of the invention. The enclosed drawings are not necessarily true to scale and are simply intended to reflect in exemplary form the general concept of the present invention. In particular, features which are contained in the figures should in no way be considered as a necessary element of the present invention.

### BRIEF DESCRIPTION OF THE SEVERAL VIEWS OF THE DRAWING

In the drawings:

FIG. 1 shows a block diagram of the electronic components of an exemplary embodiment of an apparatus according to the invention;

FIG. 2 shows a block diagram of an exemplary embodiment of a system according to the invention;

FIG. 3 shows a flow diagram of an example of a method according to the invention;

FIG. 4 shows a flow diagram of an example of a method according to the invention;

FIG. 5 shows an exemplary graphic representation of an ultrasonic echo signal represented by ultrasonic echo signal data;

FIG. 6 shows an exemplary graphic representation of an ultrasonic echo signal represented by a plurality of consecutive ultrasonic echo signal data blocks; and

FIG. 7 shows an exemplary representation of a graphic representation of ultrasonic echo signal data.

### DETAILED DESCRIPTION OF THE INVENTION

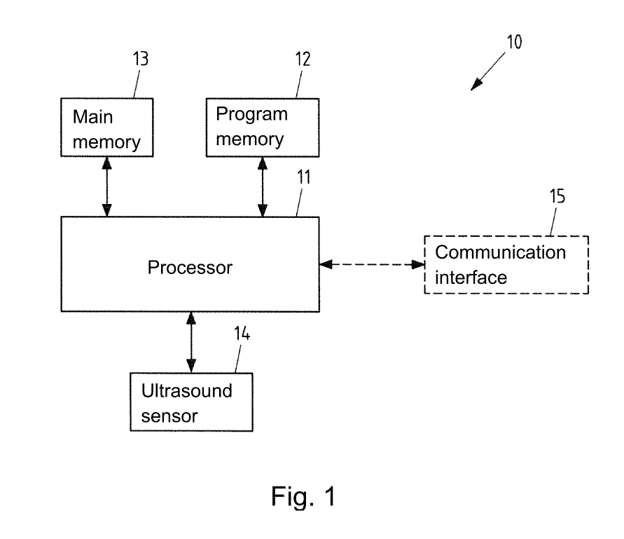

FIG. 1 is a block diagram of an exemplary embodiment of the apparatus 10 according to the invention.

Processor 11 of the apparatus 10 is, in particular configured as a microcontroller or microprocessor. Processor 11 executes program instructions which are stored in the program memory 12 and stores, for example, intermediate results or similar in the main memory 13. For example, program memory 12 is a non-volatile memory such as a flash memory, a magnetic memory, an EEPROM memory, a persistent memory such as a ROM memory and/or an optical memory. Main memory 13 is, for example, a volatile or non-volatile memory, in particular a memory with random access memory (RAM) such as a static RAM memory (SRAM), a dynamic RAM memory (DRAM).

Program memory 12 and main memory 13 are preferably arranged together with processor 11 in one module. Processor 11 is, for example, operatively connected to program memory 12 and main memory 13, for example via a bus.

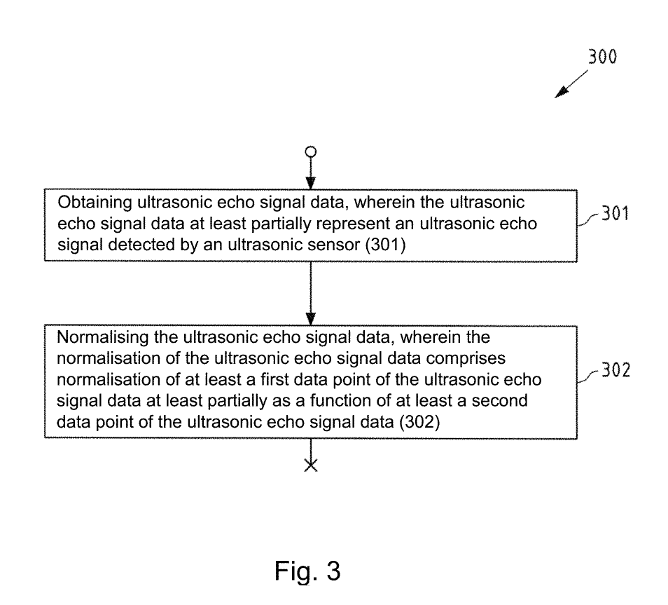

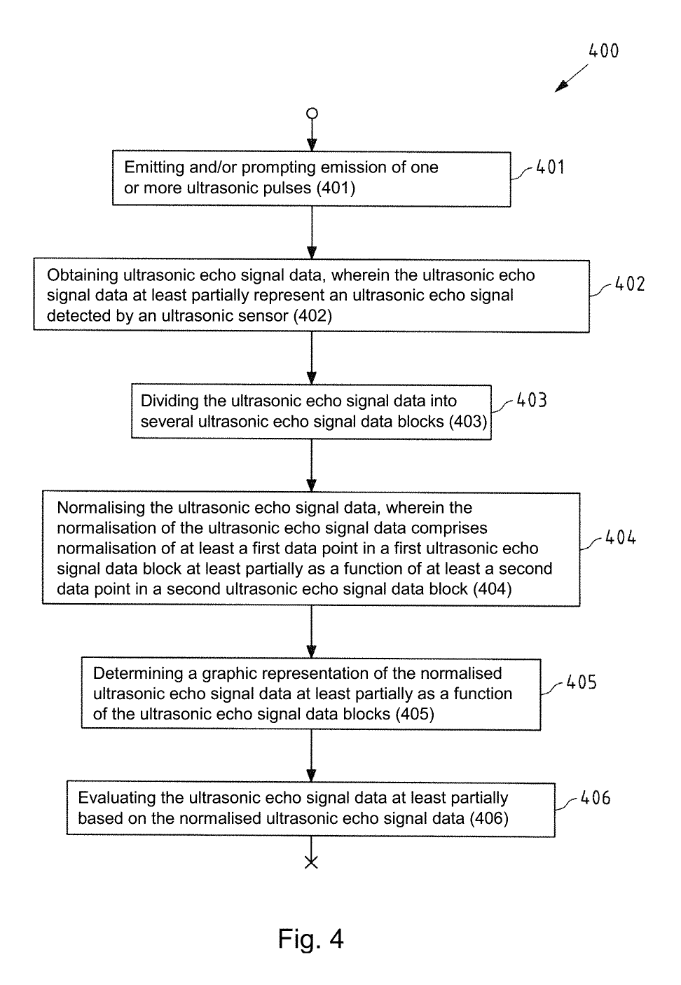

Program instructions are, for example, stored in program memory 12 which prompt the processor 11 and/or apparatus 10, when the processor 11 executes the program instructions, to at least partially perform and/or to control the method represented in FIG. 3 and/or FIG. 4.

Apparatus 10 comprises an ultrasonic sensor 14. However, embodiments are also possible in which the ultrasonic sensor 14 is not part of the apparatus 10, but rather is, for example, separate from the apparatus 10.

The ultrasonic sensor 14 is, for example, formed as a combined ultrasonic detector and ultrasonic emitter.

Accordingly, ultrasonic sensor 14 is, on the one hand, configured to detect an ultrasonic echo signal. The ultrasonic sensor 14 communicates, for example, ultrasonic echo signal data to the processor 11 which are a representation of the time curve of the signal strength of the detected ultrasonic echo signal. In order to detect the ultrasonic echo signal, the ultrasonic sensor 14 has, for example, a piezoelectric converter which converts an ultrasonic echo signal detectable at the position of the ultrasonic sensor 15 into an electric signal. The ultrasonic sensor also has, for example, additional components for processing the electric signal (e.g. one or a plurality of filters such as one or a plurality of band pass filters, a mixer such a downstream mixer, etc.) as well as for analogue-digital conversion of the electric signal and to obtain the ultrasonic echo signal data (e.g. an analogue-digital converter such as a Delta-Sigma converter and/or a parallel converter).

On the other hand, ultrasonic sensor 14 is, for example, configured to emit one or a plurality of ultrasonic pulses, for example when a corresponding control signal is obtained by processor 11 at ultrasonic sensor 14. In order to emit the ultrasonic pulses, the ultrasonic sensor 14 can also comprise a piezoelectric converter which converts an electric signal into one or a plurality of ultrasonic pulses. The same piezoelectric converter can preferably be used to emit and detect.

Processor 11 is, for example, operatively connected to ultrasonic sensor 14, for example via a bus.

The optional wireless communication interface 15 is, for example, configured to communicate according to one or a plurality of wireless communication techniques. It is assumed below for example that the wireless communication interface 15 supports communication via a local radio network and a mobile network. For example, the wireless communication interface 15 is at least partially formed by a transceiver of local radio network technology, a transceiver of mobile technology and one or a plurality of antenna. As disclosed above, an example of local radio network technology is RFID, NFC, Bluetooth and/or WLAN; and an example of mobile network technology is GSM, UMTS and/or LTE. The wireless communication interface 15 can optionally support only one of these wireless communication techniques or additional wireless and/or wired communication techniques.

The processor 11 can, for example, communicate via the wireless communication interface 15 with other apparatuses such as a remote monitoring apparatus, one or a plurality of separate ultrasonic sensors and/or additional apparatuses according to the invention. Processor 11 is, for example, operatively connected to the wireless communication interface 15, for example via a bus. The wireless communication interface 15 can obtain or request information from other apparatuses and provide it to processor 11 and/or obtain information from processor 11 and send it to other apparatuses. For example, processor 11 at least partially controls the communication interface 15.

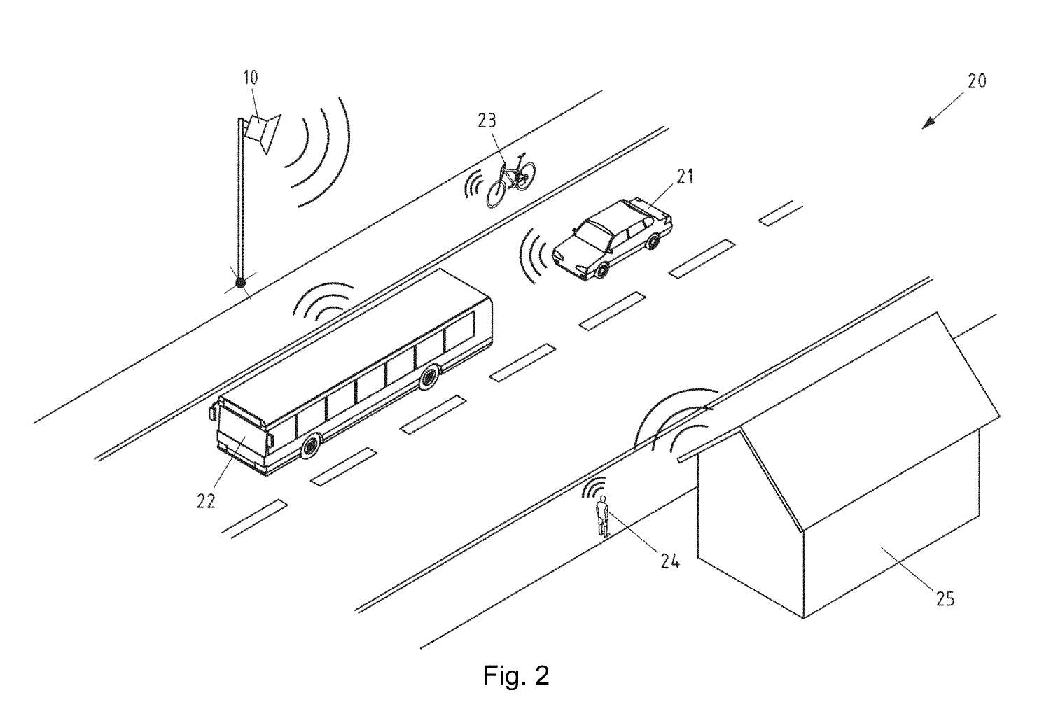

FIG. 2 is a block diagram of an exemplary embodiment of the system 20 according to the invention. The system 20 comprises the apparatus 10 with the ultrasonic sensor 14 (not represented in FIG. 2). Optionally, the system 20 can comprise further apparatuses according to the invention, ultrasonic sensors and/or ultrasonic emitters.

Apparatus 10 is mounted in system 20 for example in a sidefire configuration on a mast of a streetlamp and aligned at an angle (e.g. inclined, i.e. neither perpendicular nor horizontal) to the street surface. Both moving objects 21, 22, 23 and 24 and also stationary object 25 are located in the detection range of the ultrasonic sensor 15 in the exemplary situation represented in FIG. 2.

FIG. 3 is a flow diagram 300 which represents by way of example the steps of a method according to the invention according to the first and second aspect of the invention. The steps represented in the flow diagram 300 are performed and/or controlled by means of the apparatus 10. The steps are, for example, performed and/or controlled at least partially by the processor 11 of the apparatus 10.

Ultrasonic echo signal data are obtained at the apparatus 10 in a step 301, wherein the ultrasonic echo signal data at least partially represents an ultrasonic echo signal detected by the ultrasonic sensor 14. The ultrasonic echo signal data are, for example, obtained at the apparatus 10 by detecting the ultrasonic echo signal by means of the ultrasonic sensor 14.

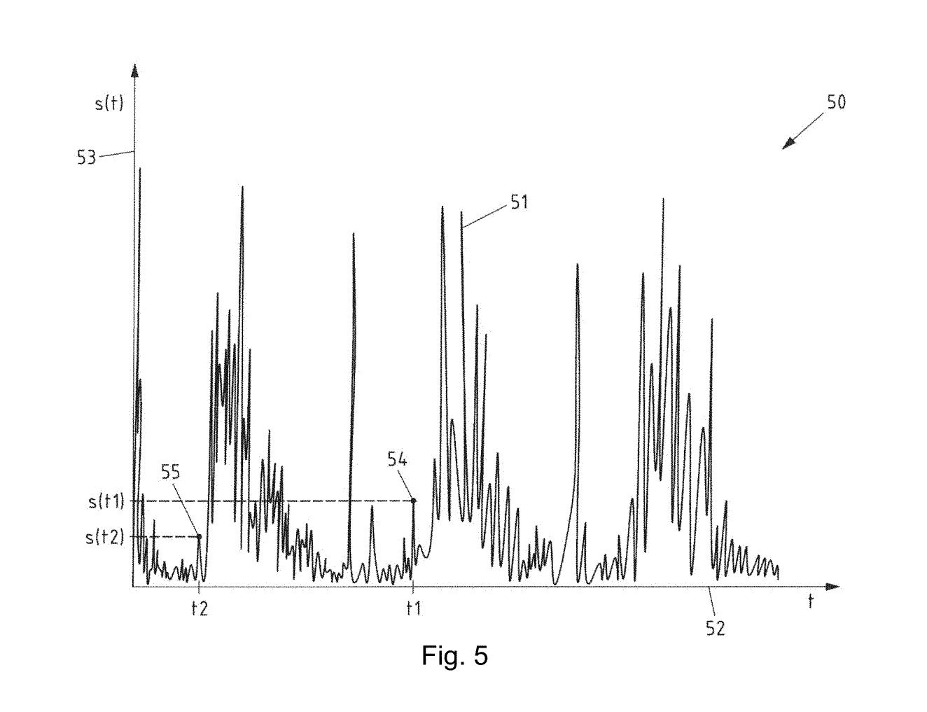

The ultrasonic echo signal data are, for example, a representation of the time curve of the signal strength of the ultrasonic echo signal detected by the ultrasonic sensor. Each data point of the ultrasonic echo signal data comprises, for example, a representation of a value of the signal strength of the detected ultrasonic echo signal at a detection time and a representation of the detection time. An exemplary graphic representation 50 of the ultrasonic echo signal 51 represented by the ultrasonic echo signal data is shown in FIG. 5. Each signal point of the ultrasonic echo signal 51 corresponds to a data point of the ultrasonic echo signal data. The ultrasonic echo signal 51 is represented in FIG. 5 as a time curve of the signal strength. Accordingly, the time t is plotted on the abscissa 52 and the signal strength s(t) on the ordinate 53.

In a step 302, the ultrasonic echo signal data are normalised, wherein the normalisation of the ultrasonic echo signal data comprises the normalisation of at least a first data point of the ultrasonic echo signal data at least partially as a function of at least a second data point of the ultrasonic echo signal data. The first data point thereby represents the value of the signal strength of the detected ultrasonic echo signal at a first detection time, and the second data point represents the value of the signal strength of the detected ultrasonic echo signal at an earlier second detection time.

A possible example of a signal point corresponding to the first data point is provided with the reference numeral 54 in the graphic representation 50 of the ultrasonic echo signal 51 represented by the ultrasonic echo signal data. In this example, the first data point, for example, comprises a representation of the value of the signal strength s(t₁) and a representation of the first detection time t₁. A possible example of a signal point corresponding to the second data point is provided with the reference numeral 55 such that the second data point comprises, for example, a representation of the value of the signal strength s(t₂) and a representation of the second detection time t₂ The second detection time t₂ is chronologically earlier than the first detection time t₁.

As described above, in the present case the normalisation of the ultrasonic echo signal data according to the first aspect of the invention should for example be understood to the effect that signal portions attributable to reflections of one or more previously emitted ultrasonic pulses from stationary and/or quasi-stationary objects (for example object 25 in FIG. 2) are at least partially reduced in the normalised ultrasonic echo signal represented by the normalised ultrasonic echo signal data in comparison with the detected ultrasonic echo signal. Accordingly, in the present case the normalisation of the ultrasonic echo signal data according to the second aspect of the invention should for example be understood to the effect that signal portions attributable to reflections of one or more previously emitted ultrasonic pulses from moving objects (for example object 21 in FIG. 2) are at least partially reduced in the normalised ultrasonic echo signal represented by the normalised ultrasonic echo signal data in comparison with the detected ultrasonic echo signal.

For example, the normalisation of at least the first data point of the ultrasonic echo signal data comprises the determination and/or selection of the second data point at least partially as a function of the first data point and the determination of a normalised first data point based at least on the first data point and the second data point. According to the first aspect of the invention, the second data point is for example determined and/or selected as a function of the first data point such that signal portions attributable to reflections of one or more previously emitted ultrasonic pulses from stationary and/or quasi-stationary objects are at least partially reduced in the ultrasonic echo signal represented by the normalised ultrasonic echo signal data in comparison with the detected ultrasonic echo signal. According to the second aspect of the invention, the second data point is for example determined and/or selected as a function of the first data point such that signal portions attributable to reflections of one or more previously emitted ultrasonic pulses from moving objects are at least partially reduced in the ultrasonic echo signal represented by the normalised ultrasonic echo signal data in comparison with the detected ultrasonic echo signal.

For example, a representation of a value of a signal strength comprised by the normalised first data point is determined based on the values of the signal strength of the detected ultrasonic echo signal represented by the first data point and the second data point.

For example, the ultrasonic echo signal data are normalised in step 302 through the processor 11 in that the processor 11 determines and/or selects at least the first and the second data point and determines the representation of a value of a signal strength comprised by the normalised first data point.

As a result of the normalisation of the ultrasonic echo signal data in step 302, normalised ultrasonic echo signal data comprising at least the normalised first data point are obtained. If necessary, as result of the normalisation of the ultrasonic echo signal data in step 302, normalised ultrasonic echo signal data according to the first aspect of the invention and normalised ultrasonic echo signal data according to the second aspect of the invention are obtained.

FIG. 4 is a flow diagram 400 which represents by way of example the steps of a method according to the invention according to the first aspect of the invention. The steps represented in the flow diagram 400 are performed and/or controlled by means of the apparatus 10. The steps are, for example, performed and/or controlled at least partially by the processor 11 of the control apparatus 10.

The apparatus 10 emits one or a plurality of ultrasonic pulses and/or prompts the emitting of the ultrasonic pulses in a step 401. For example, the ultrasonic pulses are emitted at regular time internals T_{R}. Alternatively or additionally, the emitting of the ultrasonic pulses is, for example, prompted at regular time intervals T_{R}. The emitted ultrasonic pulses are preferably identical. For example, the emitted ultrasonic pulses are based on a time-limited prototype pulse, which is modulated and/or frequency-shifted to an ultrasonic carrier frequency (e.g. 44 kHz).

For example, the ultrasonic pulses are emitted from the ultrasonic sensor 14 in step 401. The processor 11 actuates, for example, the ultrasonic sensor 14 to prompt the ultrasonic sensor 14 to emit the ultrasonic pulses.

Ultrasonic echo signal data are obtained at the apparatus 10 in a step 402, wherein the ultrasonic echo signal data at least partially represent an ultrasonic echo signal detected by the ultrasonic sensor 14. The ultrasonic echo signal data are, for example, obtained at the apparatus 10 by detecting the ultrasonic echo signal by means of the ultrasonic sensor 14. Step 402 corresponds, for example, to the step 301 described above in connection with the flow diagram 300 shown in FIG. 3.

As described above, the ultrasonic echo signal data are for example a representation of the time curve of the signal strength of the ultrasonic echo signal detected by the ultrasonic sensor. For example, the ultrasonic echo signal represented by the ultrasonic echo signal data comprises signal portions at least substantially attributable to reflections of the ultrasonic pulses emitted in step 401 on moving objects (e.g. objects 21 to 24 in FIG. 2) and stationary objects (e.g. object 25 in FIG. 2). An exemplary graphic representation 50 of the ultrasonic echo signal 51 represented by the ultrasonic echo signal data is, as described above, shown in FIG. 5.

The ultrasonic echo signal data are divided into a plurality of ultrasonic echo signal data blocks in a step 403, for example the processor 11 divides the ultrasonic echo signal data into a plurality of ultrasonic echo signal data blocks. In this case, the ultrasonic echo signal data are divided into a plurality of ultrasonic echo signal data blocks such that the ultrasonic echo signal data blocks represent consecutive time periods, of identical time period length, of the time curve of the value of the signal strength of the detected ultrasonic echo signal, wherein a first ultrasonic echo signal data block comprises the first data point and a second ultrasonic echo signal data block comprises the second data point.

For example, each of the time periods starts with the emission time of an ultrasonic pulse. This has the effect in the present case of the time period length of each of the time periods, for example, corresponding to the time interval T_{R} between the emission times of two consecutive ultrasonic pulses. The time curve of the signal strength of the detected ultrasonic echo signal represented by an ultrasonic echo signal data block is also in this case at least substantially determined by reflections of the ultrasonic pulse emitted at the beginning of the respective time period and is thus, for example, also designated below as an ultrasonic pulse response.

The beginning of a time period can, for example, take place by knowing exactly the emission times. For example, the processor 11 knows the emission time of the ultrasonic pulses when it actuates the ultrasonic sensor 14 in order to prompt the ultrasonic sensor 14 to emit the ultrasonic pulses. Alternatively or additionally, corresponding emission time data, which represent one or a plurality of emission times of one or a plurality of ultrasonic pulses, can be stored in program memory 12. Alternatively or additionally, the emission times of an ultrasonic pulse can also be determined. For example, when the ultrasonic sensor 14 is a combined ultrasonic detector and ultrasonic emitter, it can be determined by an analysis of the remaining talkback of an emitted ultrasonic pulse in the ultrasonic detector (e.g. talkback concerning common components of the ultrasonic detector and the ultrasonic emitter such as a duplexer).

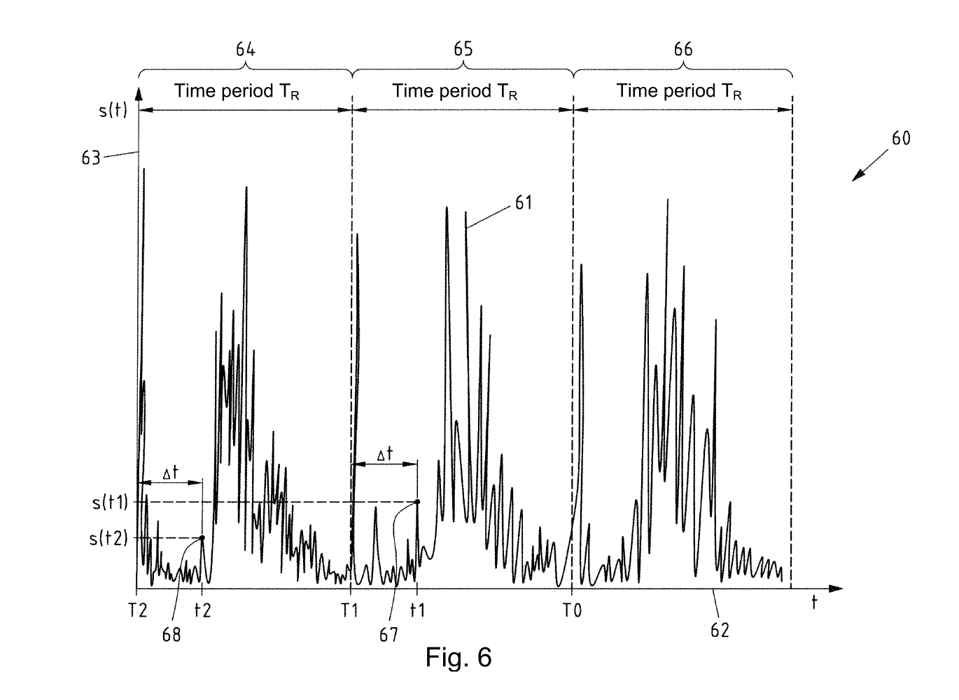

An exemplary graphic representation 60 of the ultrasonic echo signal 61 represented by three consecutive ultrasonic echo signal data blocks is shown in FIG. 6. The ultrasonic echo signal 61 corresponds to the ultrasonic echo signal 51 represented in FIG. 5. Accordingly, in FIG. 6 too, the time t is plotted on the abscissa 62 and the signal strength s(t) on the ordinate 63. The three consecutive time periods 64, 65 and 66 in each case have the time period length T_{R} and begin in each case with one of the emission times T₀, T₁ and T₂ of an ultrasonic pulse emitted in step 401. These time periods 64, 65 and 66 and the time curve of the signal strength of the ultrasonic echo signal 61 shown therein each correspond to an ultrasonic echo signal data block.

In a step 404, the ultrasonic echo signal data are normalised according to the first aspect of the invention, wherein the normalisation of the ultrasonic echo signal data according to the first aspect of the invention comprises the normalisation of at least a first data point in a first ultrasonic echo signal data block at least partially as a function of at least a second data point in a second ultrasonic echo signal data block. The first data point thereby represents the value of the signal strength of the detected ultrasonic echo signal at a first detection time, and the second data point represents the value of the signal strength of the detected ultrasonic echo signal at an earlier second detection time. For example, the first ultrasonic echo signal data block and the second ultrasonic echo signal data block are consecutive ultrasonic echo signal data blocks.

As described above, in the present case the normalisation of the ultrasonic echo signal data according to the first aspect of the invention should for example be understood to the effect that signal portions attributable to reflections of one or more previously emitted ultrasonic pulses from stationary and/or quasi-stationary objects (for example object 25 in FIG. 2) are at least partially reduced in the normalised ultrasonic echo signal represented by the normalised ultrasonic echo signal data in comparison with the detected ultrasonic echo signal.

For example, the normalisation of at least the first data point of the ultrasonic echo signal data according to the first aspect of the invention comprises the selection of at least the second data point at least partially as a function of the first data point and the determination of a normalised first data point based at least on the first data point and the second data point. Different algorithms are possible for this purpose of which one possible algorithm is described by way of example below.

For example, the second data point is determined and/or selected such that it is associated with the same signal runtime Δt as the first data point and/or is located in the second ultrasonic echo signal data block at the same position as the first data point in the first ultrasonic echo signal data block. In addition to the second data point, additional data points can be determined and/or selected such that they are in each case associated with the same signal runtime Δt as the first data point and/or are located in their respective ultrasonic echo signal data block at the same position as the first data point in the first ultrasonic echo signal data block.

A possible example of a signal point corresponding to the first data point is provided with the reference numeral 67 in the graphic representation 60 of the ultrasonic echo signal 61 represented by the ultrasonic echo signal data. In this example, the first data point, for example, comprises a representation of the value of the signal strength s(t₁) and a representation of the first detection time t₁. A possible example of a signal point corresponding to the second data point is provided with the reference numeral 68 such that the second data point comprises, for example, a representation of the value of the signal strength s(t₂) and a representation of the second detection time t₂. The second detection time t₂ is chronologically earlier than the first detection time t₁.

The time difference between the first detection time t₁ and the first emission time T1 and the time difference between the second detection time t₂ and the second emission time T2 in each case correspond to Δt. In this case, Δt corresponds to the signal runtime of the ultrasonic pulse emitted at the start of the respective time period. The distance d of the reflected object can be determined from the signal runtime Δt, provided there is no multiple reflection (e.g. with the following formula: d=Δt*v/2, with speed of sound v). Accordingly, both values of the signal strength s(t₁) and s(t₂), provided there are no multiple reflections, trace back to a reflection of the ultrasonic pulse emitted at the start of the respective time period on an object at the same distance d from the ultrasonic sensor 14.

The second data point and, if necessary, additional data points can, for example, be determined at least partially as a function of a window function h(t). For example, the window function h(t=T₁) predefines a time section as a function of the start of the first time period T₁ (i.e. of the first emission time T₁) in which the second data point and, if necessary, the additional data points are present. In this case, the window function h(t=T₁) can predefine a past time section and/or a future time section (e.g. by a delay of the real-time processing of the ultrasonic echo signal data).

The average value s̅ (T₁, Δt) and the variance σₛ²(T₁, Δt) are then, for example, determined for the values of the signal strength (e.g. s(t₁) with t₁=T₁+Δt for the first data point, s(t₂) for the second data point) of the detected ultrasonic echo signal represented by the first data point and the second data point and, if necessary, the additional data points. In this case, the window function h(t=T₁) can predefine a weighting of the values of the signal strength represented by the first data point and the second data point and, if necessary, the additional data points. The normalised first data point sₙ(t₁) can then, for example, be determined according to the following formula:

$${s}_{n} ( {t}_{1} ) = \frac{s ( {t}_{1} ) - \overline{s} ( {T}_{1} , Δ t )}{\sqrt[2]{{σ}_{s}^{2} ( {T}_{1} , Δ t )}}$$

This has the effect of the average reflection level and furthermore the fluctuation value, which is also distance-dependent, being at least partially reduced and/or compensated. As a result, a compensation and/or reduction of the statistical environmental effects is achieved, i.e. of the effects attributable to reflections from stationary and/or quasi-stationary objects.

This is, for example, advantageous in order to minimise the effects and disruptions resulting from the change both of the objects and the environment in the detection range of the ultrasonic sensor 15. These can, e.g., be slight changes (e.g. moving trees, opening windows, etc.), but also objects which are continuously added into the environment and removed therefrom (e.g. parking vehicles). In order to take these factors into account, as described above, a time window can be used (weighted function of a plurality of ultrasonic echo signal data blocks), based on which for example characteristics of the environment can be taken into account (e.g. background reflections of the environment, the ground and stationary objects) and the general changeability of the environment (size of the fluctuation of the reflections present on all sides, e.g. such as caused by the movement of the trees, vibrations, sensor errors and disruptions). Individual objects (e.g. parking cars), which continuously change the environment, can also be taken into account by means of computer following detection.

For example, the above-described normalising of at least the first data point is repeated for each data point of the ultrasonic echo signal data. For example, the first data point is in each case the data point which is to be normalised. For example, the second data point (and if necessary each of the additional data points) is in each case determined and/or selected as a function of the first data point.

As a result of the normalisation, in step 404 normalised ultrasonic echo signal data comprising at least the normalised first data point are obtained. If the normalisation is repeated for each data point of the ultrasonic echo signal data, normalised ultrasonic echo signal data are obtained as a result of the normalisation in step 404 comprising the normalised data points (e.g. exclusively comprising normalised data points).

In the normalised ultrasonic echo signal data obtained in step 404, the signal portions attributable to reflections from stationary and/or quasi-stationary objects are at least partially reduced in comparison with the ultrasonic echo signal detected by the ultrasonic sensor. These thus represent normalised ultrasonic echo signal data according to the first aspect of the invention. If necessary, normalised ultrasonic echo signal data according to the second aspect of the invention can be determined based on these normalised ultrasonic echo signal data obtained in step 404 in that the difference between these normalised ultrasonic echo signal data and the normalised ultrasonic echo signal data according to the second aspect of the invention obtained in step 402 is determined. This difference corresponds for example to the normalised ultrasonic echo signal data according to the second aspect of the invention. In these normalised ultrasonic echo signal data according to the second aspect of the invention, signal portions attributable to reflections from moving objects are at least partially reduced in comparison with the detected ultrasonic echo signal.

In a step 405, a graphic representation of the normalised ultrasonic echo signal data is determined at least partially as a function of the ultrasonic echo signal data blocks. For example, the graphic representation is and/or comprises a pixel arrangement with pixels arranged in a grid.

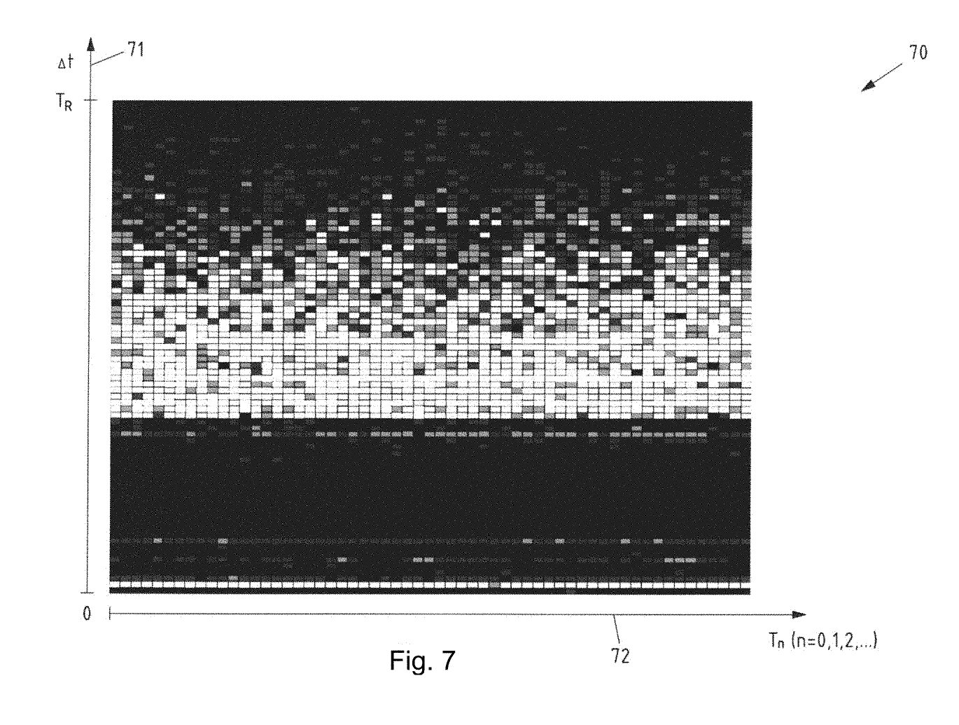

FIG. 7 shows an exemplary illustration of a graphic representation of normalised ultrasonic echo signal data. The graphic representation is a pixel arrangement 70 with pixels arranged in a grid. For example, each pixel of the pixel arrangement 70 is in each case determined as a function of a data point of the normalised ultrasonic echo signal data. For example, the grey scale of a pixel is determined as a function of the value of the signal strength (alternatively also frequency and/or phase) represented by the respective data point. In this case, all data points of an ultrasonic echo signal data block are represented by the pixels of the pixel arrangement 70 arranged in a grid column of the grid, and data points of consecutive ultrasonic echo signal data blocks are represented by the pixels of the pixel arrangement 70 arranged in consecutive grid columns of the grid. For the case described above where each time period represented by an ultrasonic echo signal data block starts with the emission time of an ultrasonic pulse, each grid column of the grid of the pixel arrangement 70 thus, for example, represents an ultrasonic pulse response of a previously emitted ultrasonic pulse.

For example, the signal runtime Δt is plotted on the ordinate 71 running in the direction of the grid columns with the maximum value T_{R}. As described above, the distance d of the reflecting object can be determined from the signal runtime Δt, provided there is no multiple reflection (e.g. with the formula: d=Δt*v/2, with speed of sound v). The ordinate can thus also be designated as the pulse response axis, distance axis or signal runtime axis. The emission times (e.g. T₀, T₁, T₂) of the ultrasonic pulses are, for example, plotted as discrete times on the abscissa 72. It thus constitutes the number of ultrasonic pulse responses detected to an ultrasonic pulse and can also be designated as a time axis.

Accordingly, the position of each pixel in FIG. 7 is determined by the emission time of the ultrasonic pulse, which determines the start of the time period of the ultrasonic echo signal data block of the respective data point, and the signal runtime associated with the respective data point. The grey scale of each pixel is also determined as a function of the value of the signal strength represented by the respective data point.

The normalised ultrasonic echo signal data can thus be further processed in this two-dimensional representation e.g. with image processing algorithms.

In possible embodiments, a graphic representation of the ultrasonic echo signal data is also determined (for example before or after step 404). This takes place for example in the same way as the determination of the graphic representation of the normalised ultrasonic echo signal data in step 405.

In a step 406, the ultrasonic echo signal data are evaluated, at least partially based on the normalised ultrasonic echo signal data.

For this purpose, one or more clustering algorithms are for example applied to the ultrasonic echo signal data and/or the normalised ultrasonic echo signal data, for example to a graphic representation of the ultrasonic echo signal data and/or the normalised ultrasonic echo signal data.

Two possible clustering algorithms are described briefly in the following by way of example:

Clustering algorithm example 1 (threshold value clustering):
1. The graphic representation of the ultrasonic echo signal data and/or the normalised ultrasonic echo signal data is first filtered with a dilation in order to fill gaps and to widen the individual measurement results.
2. The signal is then converted into a black and white picture with the aid of a threshold value which is applied to each pixel while taking into consideration the direct environment and boundary properties.
3. These data are then processed with the aid of a simple clustering algorithm. Pixels which lie in proximity to one another and which were recognised in the preceding step as being significant are assigned to the same cluster.
4. In order to compensate faults and errors in the sensors, small gaps within the cluster are closed.
5. Optionally, a last processing step can now follow in which objects which lie very close to one another, spatially or in terms of time, and were therefore assigned to the same cluster, are separated again. For this purpose, the clusters are enlarged step by step starting out from the maximum amplitude values. After falling below a certain percentage of the signal maximum, touching clusters no longer merge, as a result of which a separation is now achieved.

Clustering algorithm example 2 (modified DBSCAN)

The second example is based on the DBSCAN algorithm. For this purpose, the following modifications of the initial algorithm were carried out:
1. Adjustment of the distance calculation. In addition to the Euclidean distance, the values of the amplitudes of the signal are also taken into consideration in the calculation of the distance.
2. Other envelope formation around the core objects. The density-reachable objects include not only objects which are reachable by other core objects, but all objects which can be reached from an object belonging to a cluster. In order to prevent objects which do not belong together from being added to the same cluster, the search for density-reachable objects is discontinued after a certain number of non-density-reachable objects has been examined.

In preparation for further evaluation, characteristic data such as characteristic properties and/or characteristic values of the clusters are for example then determined. On the one hand, these can comprise information regarding the localisation, distribution, form, energy, extent and distance of the reflections within the clusters, so that the backscatter pattern can be described as accurately as possible and examined for distinctive features. Frequency and/or phase information of the ultrasonic echo signal represented by the ultrasonic echo signal data and/or of the normalised ultrasonic echo signal represented by the normalised ultrasonic echo signal data can also be considered and assigned to the individual clusters. Frequency analyses can be necessary for this purpose, for example through a continuous analysis of the phase position in order to determine phase information and/or frequency information (for example frequency shifts resulting from Doppler effects). In addition, where several ultrasonic sensors are used, merging results such as runtime, phase and frequency differences and information on different objects within the different detection ranges of the ultrasonic sensors can be used.

The recognition of moving and/or stationary objects within the detection range of the ultrasonic sensor, for example at least partially based on the results of the clustering, the determined characteristic properties and/or characteristic values of the clusters as well as possible merging results then takes place.

The invention is not limited to these evaluation methods. Rather, other evaluation methods are also possible in step 406. Finally, embodiments are also possible in which the step 406 is wholly dispensed with or in which the step 406 is carried out by another entity.

The present invention (for example the steps of the flow diagram 400 shown in FIG. 4) makes possible a non-intrusive detection of stationary and moving objects by means of ultrasonic sensors. Traffic participants can for example thereby be detected and characterised. This is, as described above, made possible through a use of modulated emitted pulses, the reflections of which from objects are detected by one or more ultrasonic sensors. The resulting reflection forms, including a possible frequency shift caused by the Doppler effect, can then be analysed and the processed data (for example the normalised ultrasonic echo signal data) merged. Furthermore, characteristic parameters can be determined for these reflections which, in the following step, are evaluated for example by adaptive algorithms and for example used for the localisation/speed determination of the vehicle or object type. Both an ultrasonic sensor and/or an ultrasonic emitter as well as a plurality of ultrasonic sensors and/or ultrasonic emitters can thereby be used. Thus, a very precise spatial localisation can be achieved, for example through partial overlapping of the detection ranges of several ultrasonic sensors. Also, in addition to improving precision, the use of several sensors can for example make it possible to determine the position and direction of movement or velocity vector in all three spatial axes (for example through frequency differences due to the Doppler effect).

Determined embodiments of the invention allow, for example the novel use of ultrasonic sensors to monitor complex environments (e.g. environments outdoors, in particular street traffic). New configurations are possible by means of the evaluation of not only one, but rather all reflections located in the coverage range, such as for example sidefire arrangement from the side of the street to monitor a plurality of lanes. The most varied target applications such as traffic monitoring or also parking space monitoring are also possible at the same time with a sensor or a sensor combination. In this case, the evaluation can be facilitated through the novel internal or graphic representation (e.g. in the form of a pixel arrangement), which allows simultaneous analysis of the time and spatial connection for the ultrasonic sensor evaluation. The normalisation method can for example be implemented at low expense in this representation and makes possible a significant reduction in interfering influences through undesired reflections from static (for example stationary) or irrelevant permanently moving (for example quasi-stationary) objects (for example trees, tree branches etc.).

The use of ultrasonic sensors constitutes the much improved alternative to the sensors used in the prior art such as for example radar sensors for ecological and economical reasons. The results can thus even be improved and optimised through the higher number of a plurality of distributed sensors at a plurality of optional points.

The exemplary embodiments of the present invention described in this specification should also be understood as being disclosed in all combinations with each other. In particular, the description of a feature included by an embodiment, provided the opposite is not explicitly explained, should also not be understood in the present case as the feature being necessary or essential for the function of the exemplary embodiment. The sequence of the method steps in the individual flow diagrams outlined in this specification is not absolutely necessary, alternative sequences of the method steps are conceivable. The method steps can be implemented in a different manner, thus an implementation in software (by program instructions), hardware or a combination of the two in order to implement the method steps is conceivable.

Terms used in the claims such as “comprise”, “have”, “contain”, “include” and the like do not exclude additional elements or steps. The wording “at least partially” includes both the case of “partially” and also the case of “fully”. The wording “and/or” should be understood as both the alternative and the combination being disclosed, i.e. “A and/or B” means “(A) or (B) or (A and B)”. A plurality of units, individuals or the like means multiple units, individuals or the like in the context of this specification. The use of the indefinite article does not exclude a plurality. An individual apparatus can perform the functions of a plurality of units or apparatuses mentioned in the claims. Reference numerals indicated in the claims should not be considered as limitations of the means and steps used.

1. Method comprising:
obtaining ultrasonic echo signal data, wherein the ultrasonic echo signal data at least partially represent an ultrasonic echo signal detected by an ultrasonic sensor,
normalising the ultrasonic echo signal data, wherein normalising the ultrasonic echo signal data comprises normalising at least one first data point of the ultrasonic echo signal data at least partially as a function of at least one second data point of the ultrasonic echo signal data, wherein the first data point represents the value of the signal strength of the detected ultrasonic echo signal at a first detection time, wherein the second data point of the ultrasonic echo signal data represents the value of the signal strength of the detected ultrasonic echo signal at an earlier second detection time, wherein normalised ultrasonic echo signal data comprising the normalised first data point are obtained as a result of normalising the ultrasonic echo signal data.

2. Method according to claim 1, the method further comprising:
emitting or prompting the emitting of one or a plurality of ultrasonic pulses.

3. Method according to claim 1, wherein the first detection time and the second detection time are in each case associated with the same signal runtime of a previously emitted ultrasonic pulse.

4. Method according to claim 1, the normalisation of at least the first data point comprising at least one of:
determining a signal strength average value at least as a function of the values of the signal strength of the detected ultrasonic echo signal represented by the first data point and the second data point;
determining at least one of a signal strength standard deviation or a signal strength variance at least partially as a function of the values of the signal strength of the detected ultrasonic echo signal represented by the first data point and the second data point;
dividing the signal strength average value by the signal strength standard deviation;
subtracting the signal strength average value from the value of the signal strength of the detected ultrasonic echo signal represented by the first data point; and
dividing the result of the subtraction of the signal strength average value from the value of the signal strength of the detected ultrasonic echo signal represented by the first data point by the signal strength standard deviation.

5. Method according to claim 1, the method further comprising:
carrying out the normalisation for each data point of the ultrasonic echo signal data.

6. Method according to claim 1, the method further comprising:
dividing the ultrasonic echo signal data into several ultrasonic echo signal data blocks, wherein the ultrasonic echo signal data blocks represent consecutive time periods, having the same time period length, of the time curve of the value of the signal strength of the detected ultrasonic echo signal, and wherein a first ultrasonic echo signal data block comprises the first data point and a second ultrasonic echo signal data block comprises the second data point.

7. Method according to claim 6, the method further comprising:
determining a graphic representation of at least one of the ultrasonic echo signal data or the normalised ultrasonic echo signal data at least partially as a function of the ultrasonic echo signal data blocks.

8. Method according to claim 7, wherein the graphic representation is or comprises a pixel arrangement with pixels arranged in a grid.

9. Method according to claim 8, wherein the pixels of each grid column of the grid are determined as a function of the data points of a respective ultrasonic echo signal data block of the ultrasonic echo signal data blocks.

10. Method according to claim 1, the method further comprising:
evaluating the ultrasonic echo signal data at least partially based on the normalised ultrasonic echo signal data.

11. Method according to claim 9, the method further comprising:
outputting a control signal at least partially based on the result of the evaluation; or
communicating the result of the evaluation at least partially to one or more further apparatuses.

12. Computer-readable memory medium having a computer program stored thereon, comprising program instructions which prompt a processor to perform or control, when the computer program runs on the processor:
obtaining ultrasonic echo signal data, wherein the ultrasonic echo signal data at least partially represent an ultrasonic echo signal detected by an ultrasonic sensor,
normalising the ultrasonic echo signal data, wherein normalising the ultrasonic echo signal data comprises normalising at least one first data point of the ultrasonic echo signal data at least partially as a function of at least one second data point of the ultrasonic echo signal data, wherein the first data point represents the value of the signal strength of the detected ultrasonic echo signal at a first detection time, wherein the second data point of the ultrasonic echo signal data represents the value of the signal strength of the detected ultrasonic echo signal at an earlier second detection time, wherein normalised ultrasonic echo signal data comprising the normalised first data point are obtained as a result of normalising the ultrasonic echo signal data.

13. Apparatus, comprising at least one processor and at least one memory with program instructions, wherein the memory and the program instructions are configured, together with at least one processor, to prompt the apparatus to perform or control:
obtaining ultrasonic echo signal data, wherein the ultrasonic echo signal data at least partially represent an ultrasonic echo signal detected by an ultrasonic sensor,
normalising the ultrasonic echo signal data, wherein normalising the ultrasonic echo signal data comprises normalising at least one first data point of the ultrasonic echo signal data at least partially as a function of at least one second data point of the ultrasonic echo signal data, wherein the first data point represents the value of the signal strength of the detected ultrasonic echo signal at a first detection time, wherein the second data point of the ultrasonic echo signal data represents the value of the signal strength of the detected ultrasonic echo signal at an earlier second detection time, wherein normalised ultrasonic echo signal data comprising the normalised first data point are obtained as a result of normalising the ultrasonic echo signal data.

14. Apparatus according to claim 13, wherein the apparatus is part of a control apparatus for controlling a lighting means or is a control apparatus for controlling a lighting means.

15. Apparatus according to claim 13, wherein the memory and the program instructions are further configured, together with at least one processor, to prompt the apparatus to perform or control:
emitting or prompting the emitting of one or a plurality of ultrasonic pulses.

16. Apparatus according to claim 13, wherein the first detection time and the second detection time are in each case associated with the same signal runtime of a previously emitted ultrasonic pulse.

17. Apparatus according to claim 13, the normalisation of at least the first data point comprising at least one of:
determining a signal strength average value at least as a function of the values of the signal strength of the detected ultrasonic echo signal represented by the first data point and the second data point;
determining at least one of a signal strength standard deviation or a signal strength variance at least partially as a function of the values of the signal strength of the detected ultrasonic echo signal represented by the first data point and the second data point;
dividing the signal strength average value by the signal strength standard deviation;
subtracting the signal strength average value from the value of the signal strength of the detected ultrasonic echo signal represented by the first data point; and
dividing the result of the subtraction of the signal strength average value from the value of the signal strength of the detected ultrasonic echo signal represented by the first data point by the signal strength standard deviation.

18. Apparatus according to claim 13 wherein the memory and the program instructions are further configured, together with at least one processor, to prompt the apparatus to perform or control:
carrying out the normalisation for each data point of the ultrasonic echo signal data.

19. Apparatus according to claim 13 wherein the memory and the program instructions are further configured, together with at least one processor, to prompt the apparatus to perform or control:
dividing the ultrasonic echo signal data into several ultrasonic echo signal data blocks, wherein the ultrasonic echo signal data blocks represent consecutive time periods, having the same time period length, of the time curve of the value of the signal strength of the detected ultrasonic echo signal, and wherein a first ultrasonic echo signal data block comprises the first data point and a second ultrasonic echo signal data block comprises the second data point.
